(19) United States
(12) Patent Application Publication
(10) Pub. No.: US 2022/0299332 A1
(43) Pub. Date: Sep. 22, 2022

(54) INFORMATION PRESENTING DEVICE, INFORMATION PRESENTING SYSTEM, INFORMATION PRESENTING METHOD, AND INFORMATION PRESENTING PROGRAM

(71) Applicant: NIPPON TELEGRAPH AND TELEPHONE CORPORATION, Tokyo (JP)

(72) Inventors: Maiko NAYA, Tokyo (JP); Masamichi HOSODA, Tokyo (JP); Akira NAKAYAMA, Tokyo (JP); Masaru MIYAMOTO, Tokyo (JP)

(73) Assignee: NIPPON TELEGRAPH AND TELEPHONE CORPORATION, Tokyo (JP)

(21) Appl. No.: 17/633,161

(22) PCT Filed: Aug. 8, 2019
(86) PCT No.: PCT/JP2019/031468

§ 371 Date: Feb. 4, 2022

(51) Int. Cl. G01C 21/34; G08G 1/01

(52) U.S. Cl. CPC G01C 21/3492; G08G 1/0108

(57) ABSTRACT

An information presentation device includes: a communication unit that receives the degree of congestion at each position on each of a plurality of routes from each of human flow sensors installed at predetermined intervals on each of the plurality of routes to a specific point; a calculation unit that calculates the required time for each time series of the route on the basis of the degree of congestion at each position in each of the routes; a prediction unit that inputs the time-series required time calculated for each of the routes to a predetermined device for predicting The required time of each of the routes learned in advance, and predicts the timing when the required time approaches the threshold for each of the routes as an output of the predetermined device; and an information management unit that identifies a route that requires inducement from the timing predicted for each of the routes, selects an incentive for prompting a change in the identified route and an inducement time for the incentive, and instructs the information presentation terminal installed at least at a starting point of the identified route to present information corresponding to the selected incentive and inducement time.

### TECHNICAL FIELD

The disclosed technology relates to an information presentation device, an information presentation system, an information presentation method, and an information presentation program.

### BACKGROUND ART

Technologies for mitigating congestion are known. For example, when congestion occurs, since there is a risk that the travel time of people will increase due to congestion and accidents will occur due to people pushing each other, it is necessary to mitigate the congestion. For example, congestion. often occurs in. fireworks festivals, large-scale events such as the Olympic Games, and facilities such as theme parks since a large number of people visit. If the congestion. situation continues, user satisfaction may decrease and a risk of accidents and troubles occurring due to the users pushing each other is concerned.

In order to mitigate the congestion, there is a method of scheduling for individuals so that the whole is not congested (see NPL 1). In addition, there is a method of inviting a group to proceed to a detour to provide inducement (see NPL 2). In addition, in the example of commuting, there is a report that a person. changes his/her behavior so as not to be congested when given an incentive reward (see NPL 3).

### CITATION LIST

### Non Patent Literature

[NPL 1] Daichi Asahi, Tomohiro Inoue, Akihiro Tsutsui, “Simulation of Crowd Optimization Using Personalized Schedules and Inducements”, Technical Report of Information Processing Society of Japan, vol. 2015-ICS-178, No. 6, 2015.

[NPL 2] Tomohito Tanaka, “The Actual State and Problems of Security Guard for Events in. Compact. City. The Case Study of Sendai”, Bulletin. of Sendai University, Vol. 48, No. 1: 1-12, 2016.

[NPL 3] Keita Uehara, Fumihiko Nakamura, Toshiyuki Okamura, “Intention. of Railway Commuters to Departure Time Shifting by Incentive Measures”, Transport. Policy Studies' Review, vol. 11, No. 4, 2009.

### SUMMARY OF THE INVENTION

### Technical Problem

NPL 1 is a method in which an individual possesses a terminal for receiving information. for mitigating congestion and the individual refers to the terminal. Since the entire scheduling can be performed by setting a threshold for the degree of congestion, countermeasures can be taken even after congestion occurs. However, in this case, the effect of congestion mitigation is small unless the schedule is frequently received in addition to the advance scheduling and a large number of users fol low the inducement.

Therefore, checking the schedule one by one on each user's terminal. during such congestion that people push each other is a method that poses a heavy burden on users

NPL 2 proposes inducement calling for avoidance from. a. congested route to a detour. However, in this method, if the number of people who follow the inducement is small, the congestion will not be mitigated in NPL 3, the effect of increasing the number of people who follow the inducement by giving an incentive can be expected as compared with NPL 2. However, the proposal of NPL 3 is an inducement method for shifting the time, and is not effective when the time is uniquely determined such as when leaving an event. Moreover, this is not a method that. can immediately obtain an effect in the state of congestion.

An object of the present disclosure is to provide an information presentation device, an information presentation system, an information presentation method, and an information presentation program capable of performing inducement in real time according to the congestion of a route and mitigating the congestion.

### Means for Solving the Problem

A first aspect of the present disclosure is an information presentation device including: a communication unit that receives the degree of congestion at each position on each of a plurality of routes from each of human flow sensors installed at predetermined intervals on each of the plurality of routes to a specific point; a calculation unit that calculates the required time for each time series of the route on the basis of the degree of congestion at each position in each of the routes; a prediction unit that inputs the time-series required time calculated for each of the routes to a predetermined device for predicting the required time of each of the routes learned in advance, and predicts the timing when the required time approaches the threshold for each of the routes as an output of the predetermined device; and an information management unit that identifies a route that requires inducement from the timing predicted for each of the routes, selects an incentive for prompting a change in the identified route and an inducement time for the incentive, and instructs the information presentation terminal installed at least at a starting point. of the identified route to present information corresponding to the selected incentive and inducement time.

A second aspect of the present disclosure is an information presentation system including: human flow sensors installed at predetermined intervals on each of a plurality of routes to a specific point; information presentation terminals installed at least at a starting point of each of the routes; a communication unit that receives the degree of congestion at each. position in each of the routes from each of the human flow sensors; a calculation unit that calculates the required time for each time series of the route on the basis of the degree of congestion at each position in each of the routes; a prediction unit that inputs the time-series required time calculated for each of the routes to a predetermined device for predicting the required time of each of the routes learned in advance, and predicts the timing when the required time approaches the threshold for each of the routes as an output of the predetermined device; and an information management unit that identifies a route that requires inducement from the timing predicted for each of the routes, selects an incentive for prompting a change in the identified route and an inducement time for the incentive, and instructs the information presentation terminal installed at a point of the identified route to present information corresponding to the selected incentive and inducement time.

A third aspect of the present disclosure is an information presentation method for causing a computer to execute processing including: receiving the degree of congestion at each position on each of a plurality of routes from each of human flow sensors installed at predetermined intervals on each of the plurality of routes to a specific point; calculating the required time for each time series of the route on. the basis of the degree of congestion at each position in each of the routes; inputting the time-series required time calculated for each of the routes to a predetermined device for predicting the required. time of each of the routes learned in advance, and predicting the timing when the required time approaches the threshold for each of the routes as an output of the predetermined device; and identifying a route that requires inducement from the timing predicted for each of the routes, selecting an incentive for prompting a change in the identified route and an inducement time for the incentive, and instructing the information presentation terminal installed at least at a starting point of the identified route to present information corresponding to the selected incentive and inducement time.

A fourth aspect of the present disclosure is an information presentation program for causing a computer to execute: receiving the degree of congestion at each position on each of a plurality of routes from each of human flow sensors installed at predetermined intervals on each of the plurality of routes to a specific point; calculating the required time for each time series of the route on the basis of the degree of congestion at each position in each of the routes; inputting the time-series required time calculated for each of the routes to a predetermined device for predicting the required time of each of the routes learned in advance, and predicting the timing when the required time approaches the threshold for each of the routes as an output of the predetermined device; and identifying a route that requires inducement from the timing predicted for each of the routes, selecting an incentive for prompting a change in the identified route and an inducement time for the incentive, and instructing the information presentation terminal installed at least at a starting point of the identified route to present information corresponding to the selected incentive and inducement time.

### Effects of the Invention

According to the disclosed technology, it is possible to perform inducement i.n real time according to the congestion of the route and mitigate the congestion.

### BRIEF DESCRIPTION OF DRAWINGS

FIG. 1 is a diagram illustrating an example of the flow of people in each route.

FIG. 2 is a diagram illustrating an example of a case where a human flow sensor and an information presentation terminal are installed on a route.

FIG. 3 is a block diagram illustrating a configuration of an information. presentation. system of the present embodiment.

FIG. 4 is a block diagram illustrating a hardware configuration. of an information presentation device.

FIG. 5 is a diagram illustrating an image of the content of information presentation.

FIG. 6 is a diagram illustrating the relationship between the required time and the inducement time when the required time is reduced.

FIG. 7 is a diagram illustrating the relationship between the required time and the inducement time when the required time increases.

FIG. 8 is a sequence diagram illustrating the flow of an information presentation process by the information presentation system.

FIG. 9 is a sequence diagram illustrating the flow of an information presentation process by the information presentation system.

### DESCRIPTION OF EMBODIMENTS

Hereinafter, an example of an embodiment of the disclosed technique will be described with reference to the drawings. The same or equivalent components and parts in each drawing are denoted by the same reference numerals. In addition, the dimensional ratios in the drawings are exaggerated for convenience of explanation and may differ from the actual ratios.

The background and outline of the present disclosure will be described.

First, as a background, methods for mitigating congestion in the currently known method will be described. For example, a method (1) of managing the flow of people by distributing a schedule in a non-congested hour for each individual is known. A method (2) of controlling the flow of people by inducing them over voice is known. A method (3) of giving incentives or the like to cooperators who use a route during off-peak hours of the route is known. Here, the methods (1) and (2) do not have the effect of mitigating congestion when there are many people who do not follow the management. The method (3) cannot be used in cases where the time is uniquely fixed such as when leaving an event or cases where congestion has already occurred.

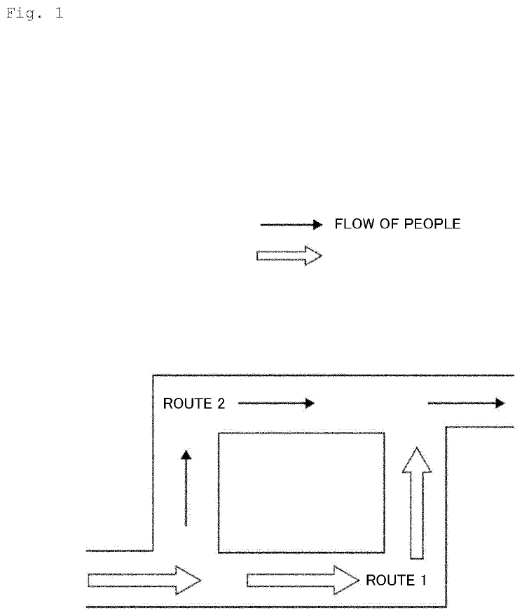

Here, the tendency of the flow of people in a route will be discussed. FIG. 1 is a diagram illustrating an example of the flow of people in each route. In FIG. 1, a route indicated by thick arrows illustrates a route along which a large number of people are moving, and a route indicated by thin arrows illustrates a route along which a small number of people are moving. As illustrated in FIG. 1, the psychology that a per, on walks following a previous person, that is, the principle of social proof that people tend to follow the choice of many people than the right choice works. Therefore, it i s considered that congestion can be avoided if a flow of a large number of people can be created in a detour where there are few people in the route. Therefore, in order to eliminate congestion that occurs from time to time, the present embodiment proposes a method of inducing a person who is about to follow a congested route to a vacant route at an appropriate timing.

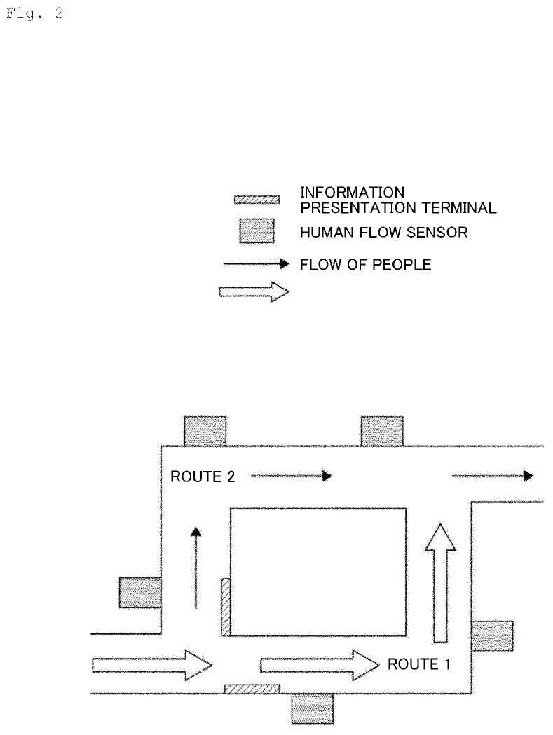

In the present embodiment, congestion is mitigated by an information presentation system FIG. 2 is a diagram illustrating an example of a case where a human flow sensor and an information presentation terminal are installed on a route. As illustrated in FIG. 2, a human flow sensor chat detects the degree of congestion from the number of people at each point and an information presentation terminal that induces people are installed on a route. The information presentation system includes each of the sensors, each of the information presentation terminals, and an information presentation device that calculates the required time of each route from the degree of congestion and identifies a route that requires inducement. The information presentation device predicts the timing when the required time exceeds a threshold using a simulator from the required time of each time series of the route. Then, the information presentation device identifies a congested route, that is, a route that requires inducement from the timing, and presents information to an inf=ation presentation terminal of the identified route with an incentive preferred by a person. Then, the information presentation device ends the information presentation when the required times equalized in each route. At that time, the information presentation device records the result of the timing when the information presentation is started and the time taken to mitigate the, congestion as needed for the incentive used for the information presentation, and optimizes the inducement time of the incentive so as to feed back the result. As described above, in the present embodiment, congestion mitigation is promoted by a method of controlling the flow of people by performing inducement at an appropriate timing. When congestion occurs in a certain route, if an incentive is given to a non-congested route, people will gather, and a following group will also choose a vacant route due to the gathered people, and the congestion of the congested route is mitigated. Further, since the present embodiment is a system for presenting information to a group, information can be presented regardless of whether an individual has a terminal and whether a dedicated application is installed on the terminal of the individual.

Hereinafter, the configuration of the present embodiment will be described. As a premise, the route to be induced in the present embodiment is a route to a specific point, and it is assumed that there is a plurality of routes. Further, in the examples of FIGS. 1 and 2, the case of a route that branches into two has been described, but the same applies to a route that branches into three or more routes.

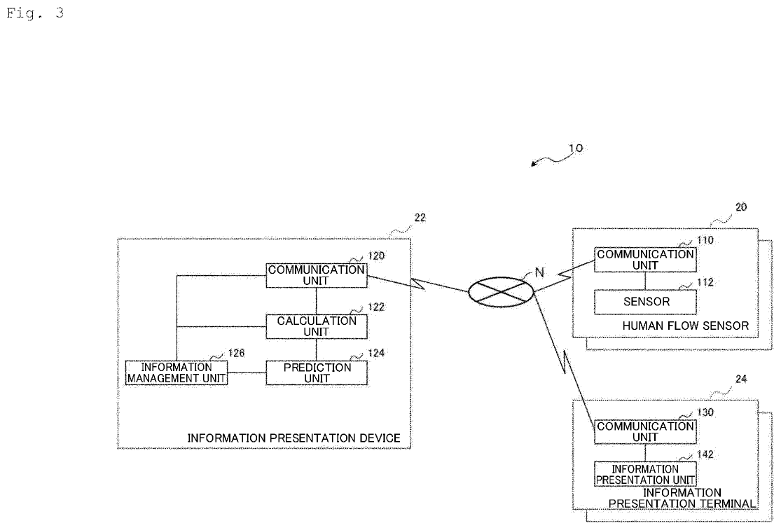

FIG. 3 is a block diagram illustrating the configuration of the information presentation system of the present embodiment.

As illustrated in FIG. 3, an information presentation system 10 includes a plurality of human flow sensors 20, an information presentation device 22, and a plurality of information presentation. terminals 24. The plurality of human flow sensors 20, the information presentation device 22, and the plurality of information presentation terminals 24 are connected by a predetermined network N (for example, an Internet line or the like).

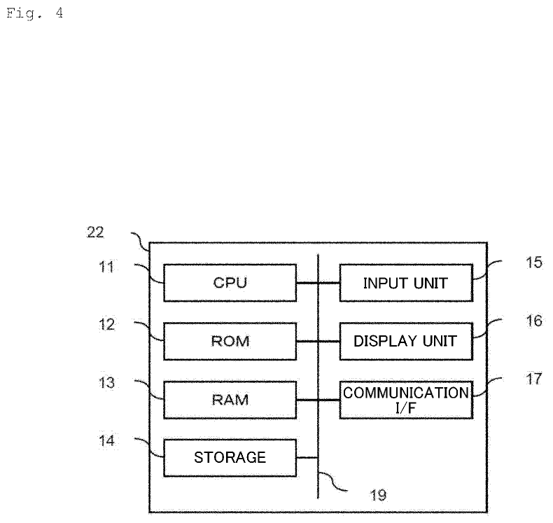

FIG. 4 is a block diagram illustrating a hardware configuration of the information presentation device 22.

As illustrated in FIG. 4, the information presentation device 22 includes a CPU (Central Processing Unit) 11, a ROM (Read Only Memory) 12, a RAM (Random Access Memory) 13, a storage 14, an input unit 15, a display unit 16, and a communication interface (I/F) 17. The components are connected to each other via a bus 19 so as to be communicable with each other.

The CPU 11 is a central arithmetic processing unit that executes various programs and controls each part. That is, the CPU 11 reads a program from the ROM 12 or the storage 14, and executes the program using the RAM 13 as a work area. The CPU 11 controls each of the above-mentioned components and. performs various arithmetic processes according to the program stored in the RUM 12 or the storage 14. In the present embodiment, an information presentation program is stored in the RUM 12 or the storage 14.

The ROM 12 stores various programs and various types of data. The RAM 13 temporarily stores a program or data as a work area. The storage 14 is composed of an HDD (Hard Disk Drive) or an SSD (Solid State Drive), and stores various programs including an operating system and various types of data.

The input unit 15 includes a pointing device such as a mouse and a keyboard, and is used for inputting various types of information.

The display unit 16 is, for example, a liquid crystal display and displays various types of information. The display unit 16 may adopt a touch panel method and may function as the input unit 15.

The communication interface 17 is an interface for communicating with other devices such as terminals, and for example, standards such as Ethernet (registered trademark), FDDI, and Wi-Fi (registered trademark) are used.

The above is the hardware configuration of the information presentation device 22. The human flow sensor 20 and the information presentation terminal 24 can also be configured as the same hardware as the information presentation device 22. In the following description, reference numerals will be omitted for the internal hardware components such as the CPU of the human flow sensor 20 and the information presentation terminal 24.

The human flow sensor 20 includes a communication unit 110 and a sensor 112. The human flow sensors 20 are installed at predetermined intervals in each of the routes. The sensor 112 detects the degree of congestion at each position on the route. The degree of congestion is, for example, the number of people observed within a range that can be detected by the sensor 112. The communication unit 110 transmits the degree of congestion to the information presentation device 22 at regular intervals. As the sensor 112 for measuring the degree of congestion, a camera, an infrared sensor, or the like can be considered, but the means of the sensor is not particularly limited.

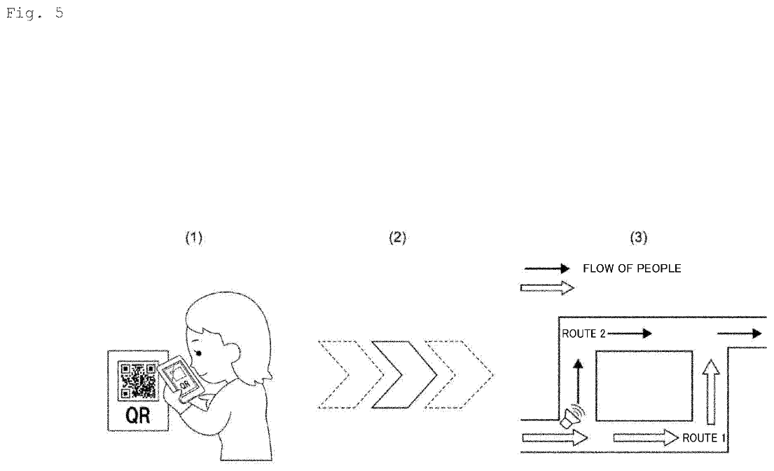

The information presentation terminal 24 includes a communication unit 130 and an information presentation unit 132. The information presentation terminal 24 includes a plurality of devices (not illustrated) such as a signage and a directional speaker as the information presentation unit 132, and induces a person to a route in which the information presentation terminal 24 is installed with the aid of these devices. The information presentation terminal 24 is installed at each starting point of the route. One information presentation terminal 24 is installed at the starting point of the route so as to correspond to one route in a one-to-one correspondence. This is to induce people to the route. The communication unit 130 receives an information presentation instruction, a change instruction, or an end instruction corresponding to the incentive and the inducement time from the information presentation device 22. The information presentation unit 132 presents information on the basis of the received incentive and the inducement time. Here, the inducement time is a designation of a start time and an end time for inducing a person by presenting information of a certain incentive. The information presentation unit 132 starts presenting information with an instructed incentive when the start time comes. FIG. 5 is a diagram illustrating an image of the content of the information presentation. The incentive in information presentation is information for promoting a change in the route, and may be any information as long as it can induce a person. As illustrated in (1) of FIG. 5, for example, information presentation in which a QR code (registered trademark) is presented to generate coupons, money, points, or the like is given as an example of incentive-based information presentation. In addition, the information presentation terminal 24 presents information and displays information for assisting the moving speed of the person to be induced. As illustrated in (2) of FIG. 5, the information presentation terminal 24 displays a light flowing animation using the travelling of a person. This animation blinks light so that it flows toward a desired place where people walk at a desired walking speed. The display of such an animation plays an auxiliary role of facilitating the smooth movement of a person. Further, as illustrated in (3) of FIg. 5, the information presentation terminal 24 may play an announcement or music prompting inducement using a directional speaker.

Next, each functional configuration of the information. presentation device 22 will be described. Each functional configuration is realized by the CPU 11 reading the information presentation program stored in the ROM 12 or the storage 14, deploying the information presentation program into the RAM 13, and executing the program.

The information presentation device 22 includes a communication unit 120, a ca1culation unit 122, a prediction unit 124, and an information management unit 126.

The communication unit 120 receives the degree of congestion at each position in each of the routes from each of the human flow sensors 20. The communication unit 120 receives the degree of congestion at regular intervals. Further, the communication unit 120 transmits an information presentation instruction corresponding to the incentive and the inducement time of the route identified by the information management unit 126 to the information presentation terminal 24 of the identified route. Further, the communication unit 120 transmits an end instruction to the information presentation terminal 24 at the end of the information presentation.

The calculation unit 122 calculates the required time for each time series of the route on the basis of the degree of congestion at each position in each of the routes. The required time can be calculated using any method as long as the time for a person to walk from the starting point to the ending point of the route can be calculated. from the degree of congestion at each position of the route. The time-series required time is a history in which the required time at the current time is expressed in a time-series order from the required time at a certain past time. The calculation unit 122 records the calculated time-series required time in the information management unit 126. The calculation unit 122 calculates the required time at the current time, and the prediction unit 124 predicts the required time in the future.

The prediction unit 124 inputs the time-series required time calculated for each of the routes by the calculation unit 122 into the simulator, and predicts the timing at which the required time approaches a threshold for each of the routes as the output of the simulator. The simulator is a multi-agent simulator (not illustrated) for predicting the required time of each of the pre-learned routes. The simulator predicts the transition of the future required time from the current time for each of the routes. In this prediction, a first threshold for a congested state and a second threshold for a congestion mitigation state are set in advance. In the prediction of the required time for the route when the route is congested, the required time exceeding the first threshold is predicted. Further, when the congestion or the route is mitigated by information presentation, the required time below the second threshold is predicted. That is, the timing close to the threshold is the timing exceeding the first threshold or the timing below the second threshold. The simulator is an example of a predetermined device, and any device that can predict the timing may be used. Further, the first threshold and the second threshold may be different or the same.

The information management unit 126 identifies the route that needs inducement from the predicted timing for each of the routes. The route that requires inducement is, for example, a route that intersects the route that is predicted. to exceed the first threshold most recently in the prediction and is a route in which the required time is smaller than the route. When congestion is predicted in this way, it is desirable to induce people to another route to mitigate the congestion. The information management unit 126 selects an incentive for prompting a change of route and an inducement time for the incentive in the identified route. The type of incentive is set in advance for each route. The inducement time for the incentive is calculated in advance, but the method of obtaining the same will be described later. Which incentive and inducement time should be selected may be designed so as to appropriately select an appropriate incentive from the current time and the predicted timing. For example, the selection of the incentive and the inducement time may be determined according to the hour and the type of event. The information management unit 126 instructs the information presentation terminal 24 installed on the identified route to present information corresponding to the selected incentive and inducement time. The information presentation instruction is transmitted from the communication unit 120 to the corresponding information presentation terminal 24. The information presentation. instruct on by the information management unit 126 is transmitted. from. the communication unit 120 to the information presentation terminal 24 at the time when the information presentation is started. Further, the information management unit 126 instructs the information presentation terminal 24 to end the information presentation defined by the incentive inducement time. The start time and the end time of information presentation may be transmitted to the information presentation terminal 24, and the information presentation terminal 24 may control the start and end of the information presentation.

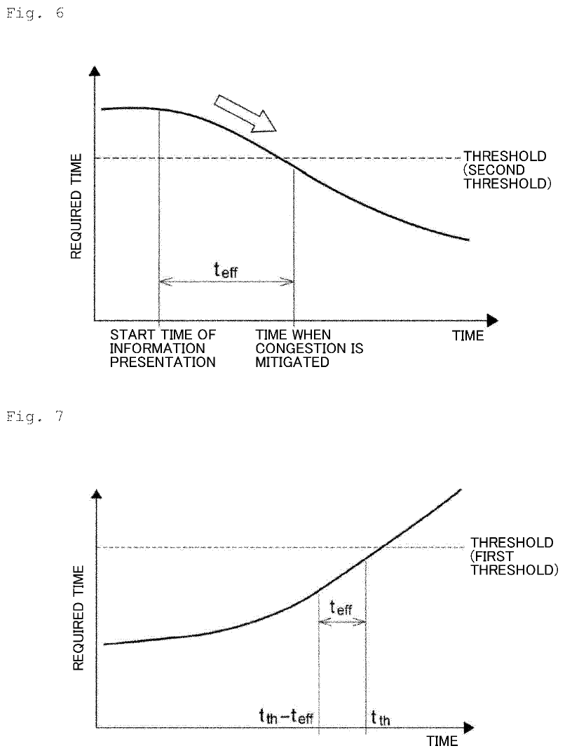

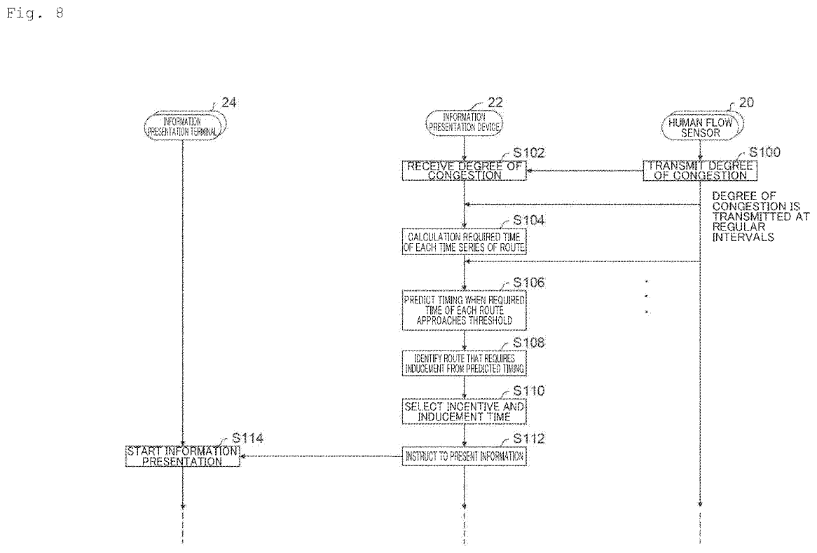

Here, a method of obtaining the incentive inducement time will be described. The information management unit 126 records the incentive and the inducement time of the incentive in association with each other. The incentive inducement time is obtained from the record. after the time from. the time (start time) when the information is actually presented by the incentive to the time (end time) when the congestion is mitigated is recorded. The time when the congestion is mitigated is, for example, the time when the required time falls below the second threshold as described above. In the information management unit 126, the incentive inducement time may be obtained in advance by an average value, a weighted average, and the like of these records, or a predetermined learning method. FIG. 6 is a diagram illustrating the relationship between the required time and the inducement time when the required time is reduced. As illustrated in FIG. 6, the time from the time when the information presentation is started to the time when the congestion is mitigated is obtained as an incentive inducement time t_{eff}. The incentive inducement time t_{eff} means the required time for the information presentation to be effective. FIG. 7 is a diagram illustrating the relationship between the required time and the inducement time when the required time increases. In FIG. 7, the timing when the first threshold is exceeded is represented by tₜₕ. The information management unit 126 obtains a time obtained by subtracting the incentive inducement time t_{eff} from the timing tₜₕ when the first threshold is exceeded as a time at which information presentation is started in. the information presentation corresponding to the incentive and the inducement time.

The required time is expected to change depending on the degree of congestion at that time. In consideration of such a change, after the information management unit 126 instructs the information presentation terminal 24 to present the information, the prediction. unit 124 predicts the timing again using the required time calculated by the calculation unit 122 after the information presentation. instruction. is issued as an input to the simulator. In addition, the information management unit 126 determines whether it is necessary to change the information presentation from the timing predicted again. When it is determined that it is necessary to change the information presentation, the information management unit 126 selects an incentive for the timing predicted again and an inducement time for the incentive, and instructs to change the information presentation. For example, at the timing of re-prediction, it is expected that the information presentation will mitigate the congestion and reduce the required time. At this time, it is assumed that the degree of reduction in the required. time is more gradual or steeper than expected. If there is a change in required time different from expected, the information management unit 126 determines that it is necessary to change the information presentation. If the degree of reduction in the required time is gradual, the information management unit 126 instructs to change the information presentation so as to increase the degree of incentive or extend the inducement. time, for example. Further, if the degree of reduction in the required time is steep, the information management unit 126 instructs to change the information presentation so as to lower the incentive or shorten the inducement time, for example. At this time, constraint conditions such as determining the upper limit of the incentive may be provided so as not to give too much incentive. In addition to increasing or decreasing the degree of incentive, the type of incentive maybe changed, and for example, a coupon may be changed to points.

Next, the operation of the information presentation system 10 will be described.

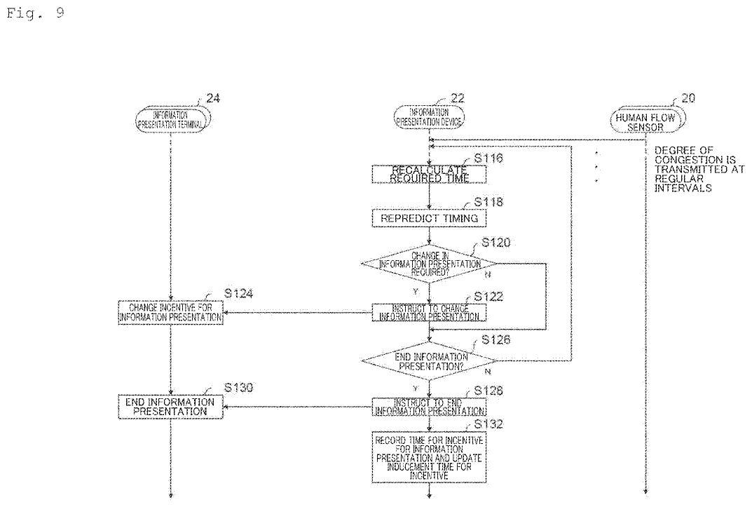

FIGS. 8 and 9 are sequence diagrams illustrating the flow of an information presentation process by the information presentation system 10.

In step S100, the CPU of the human flow sensor 20 detects the degree of congestion as the sensor 212 and transmits the same to the information presentation device 22 as the communication unit 110 at regular intervals.

Hereinafter, processing is performed by the information presentation device 22 and the information presentation terminal 24. The information presentation process is performed by the CPU 11 of the information presentation device 22 reading the information presentation processing program from the RUM 12 or the storage 14, deploying the same into the RAM 13, and executing the same.

In step S102, the CPU 11 receives the degree of congestion at each position in each of the routes from each of the human flow sensors 20 as the communication unit 120. Since the degree of congestion is transmitted from each of the human flow sensors 20 at regular intervals, the latest degree of congestion is acquired when the degree of congestion is used in the information presentation device 22 in the subsequent steps.

In step S104, the CPU 11 as the calculation unit 122 calculates the required time for each time series of the route on the basis of the degree of congestion at each position in each of the routes. The CPU 11 records the calculated required time in the information management unit 126.

In Step S106, the CPU 11 as the prediction unit 124 inputs the time-series required time calculated for each of the routes in step S104 to the simulator, and predicts the timing at which the required time approaches the threshold for each of the routes as the output of the simulator.

In step S108, the CPU 11 as the information management unit 126 identifies the route that needs inducement from the predicted timing for each of the routes.

In. step S110, the CPU 11 as the information management unit 126 selects an incentive for prompting the change of the route and the inducement time for the incentive in the identified route.

In step S112, the CPU 11 as the information management unit 126 instructs the information presentation terminal 24 installed on the identified route to present information corresponding to the selected incentive and the inducement time. The information presentation instruction is transmitted from the communication unit 120 to the corresponding information presentation terminal 24.

In step S114, the CPU of the information presentation terminal 24 receives the information presentation instruction as the communication unit 130, and starts the information presentation with the incentive in the instructed information presentation as the information presentation unit 132.

In step S116, the CPU 11 as the calculation unit 122 re-calculates the required time.

In step S118, the CPU 11 as the prediction unit 124 re-predicts the timing using the required time re-calculated in step S116 as an input to the simulator.

In step S120, the CPU 11 as the information management unit 126 determines whether the information presentation needs to be changed from the timing predicted again. The CPU 11 proceeds to step S122 when the change is necessary, and the CPU 11 proceeds to step $126 when the change is not necessary.

In step S122, the CPU 11 as the information management unit 126 selects an incentive for the timing re-predicted in step S118 and an inducement time for the incentive, and instructs to change the information presentation. The CPU 11 as the communication unit 120 transmits an instruction to change the information presentation to the information presentation terminal 24.

In step S124, the CPU of the information presentation terminal 24 receives an instruction to change the information presentation as the communication unit 130, and changes the incentive for information presentation as the information presentation unit 132.

In step S126, the CPU 11 as the information management unit 126 determines whether the information presentation is to be ended. The CPU 11 proceeds to step S128 when information presentation is to be ended, and the CPU il returns to step S116 and repeats the process when information presentation is not to be ended. The condition for ending the information presentation is, for example, when the required time re-calculated in step S116 is less than the second threshold, or when the end time of the inducement time of the incentive for information presentation. currently instructed is reached.

In step S128, the CPU 11 as the information management unit 126 instructs the end of information presentation. The CPU 11 as the communication unit 120 transmits an instruction to end the information presentation to the information presentation terminal 24.

In step 8130, the CPU of the information presentation terminal 24 receives the end instruction as the communication unit 130, and ends the information presentation as the information presentation unit 132. At this time, the information presentation device 22 may be notified that the information presentation has been ended.

In step S132, the CPU 11 records The time from the time when the information is presented to the time when the congestion is mitigated for the incentive for the information presentation and updates the incentive inducement time. Further, when the incentive for information presentation is changed in step 8122, the CPU 11 may learn the time-series pattern of each incentive for information presentation as a model of a neural network, and update the inducement time of each incentive. In this way, the incentive inducement time is updated by the record at the time when the information presentation is ended. As a result, the latest situation can be reflected in the inducement time.

The information presentation system 10 continues the sequence of each of the above-mentioned steps in a scene that requires inducement.

As described above, according to the information presentation system 10 of the present embodiment, it is possible to perform inducement according to the congestion of the route in real time and mitigate the congestion.

Although the case where the information presentation terminal 24 is installed at the starting point of a route has been described as an example, the present invention. is not limited thereto. For example, the information presentation terminal 24 may be installed at the starting point and the ending point of the route, and at the information presentation terminal 24 at the ending point an incentive may be further provided. As a result, the incentive for the route to be induced can be increased. Further, a temporary incentive may be given at the information presentation terminal 24 at the starting point, and the incentive may be determined at the information presentation terminal 24 at the ending point. As a result, it is possible to prevent a person from taking only an incentive and following a different route, and to reliably induce the person.

In addition, the start time of information presentation, the time (inducement time) in which information was presented from the start to the end of information presentation, and the change over time in the required time (degree of congestion) may be recorded, and learning may be performed from the recorded results. As the method used for learning, any method may be used from various methods using a neural network. In learning, the pattern of selection of which incentive and inducement time should be used, and the timing of starting information presentation with the selected incentive for the timing exceeding the predicted threshold are learned so that the congestion time becomes shorter. At that time, event information such as an event content, an event start time, and an event end time, which are factors that cause congestion, may be created in a database and be used as learning data. In addition, past learning results may be used for events with similar conditions.

Various processors other than, the CPU may execute the information presentation process executed by the CPU reading the software (program) in the above-mentioned embodiment. In this case, examples of the processors include a PLD (Programmable Logic Device) whose circuit configuration can be changed after manufacturing such as an FPGA (Field-Programmable Gate Array), and a dedicated electric circuit such as an ASIC ((Application Specific Integrated Circuit), which is a processor having a circuit configuration designed exclusively for the purpose for executing specific processing. Further, the information presentation process may be executed by one of these various processors, or may be executed by a combination of two or more processors of the same type or different types (for example, a plurality of FPGAs and a combination of a CPU and an FPGA). Further, the hardware structure of these various processors is, more specifically, an electric circuit in which circuit elements such as semiconductor elements are combined.

Further, in the above-mentioned embodiment, a mode in which the information presentation program is stored (installed) in the storage 14 in advance has been described, but the present invention is not limited thereto. The program is may be provided in the form of a non-transitory storage medium such as a CD-ROM (Compact Disk Read Only Memory), a DVD-ROM (Digital Versatile Disk Read Only Memory), and a USB (Universal Serial Bus) memory. Further, the program may be downloaded from an external device via a network.

Regarding the above-mentioned embodiments, the following additional notes will be further disclosed.

(Note I)

An information presentation device including: a memory;

at least one processor connected to the memory,

wherein the processor is configured to execute:

receiving the degree of congestion at each position on each of a plurality of routes from each of human flow sensors installed at predetermined intervals on each of the plurality of routes to a specific point;

calculating the required time for each time series of the route on the basis of the degree of congestion at each position in each of the routes;

inputting the time-series required time calculated for each of the routes to a predetermined device for predicting the required time of each of the routes learned in advance, and predicting the timing when the required time approaches the threshold for each of the routes as an output of the predetermined device; and identifying a route that requires inducement from the timing predicted for each of the routes, selecting an incentive for prompting a change in the identified route and an inducement time for the incentive, and instructing the information presentation terminal installed at least at a. starting point of the identified route to present information corresponding to the selected incentive and inducement time.

(Note 2)

A non-transitory storage medium having stored therein an information presentation program for causing a computer to execute: receiving the degree of congestion at each position on each of a plurality of routes from each of human flow sensors installed at predetermined intervals on each of the plurality of routes to a specific point;

calculating the required tame for each time series of the route on the basis of the degree of congestion at each position in each of the routes;

inputting the time-series required. time calculated for each of the routes to a predetermined device for predicting the required time of each of the routes learned in advance, and predicting the timing when the required time approaches the threshold for each of the routes as an output of the predetermined device; and

identifying a route that requires inducement from the timing predicted for each of the routes, selecting an incentive for prompting a change in the identified route and an inducement time for the incentive, and instructing the information presentation terminal installed at least at a starting point of the identified route to present information corresponding to the selected incentive and inducement time.

### REFERENCE SIGNS LIST

10 Information presentation system
20 Human flow sensor
22 Information presentation device
24 Information presentation terminal
110, 120, 130 Communication unit
112 Sensor
122 Calculation unit
124 Prediction unit
126 Information management unit
132 Information presentation unit

1. An information presentation device comprising:
a communication unit that receives the degree of congestion at each position on each of a plurality of routes from each of human flow sensors installed at predetermined intervals on each of the plurality of routes to a specific point;
a calculation unit that calculates the required time for each time series of the route on the basis of the degree of congestion at each position in each of the routes;
a prediction unit that inputs the time-series required time calculated for each of the routes to a predetermined device for predicting the required time of each of the routes learned in advance, and predicts the timing when the required time approaches the threshold for each of the routes as an output of the predetermined device; and
an information management unit that identifies a route that requires inducement from the timing predicted for each of the routes, selects an incentive for prompting a change in the identified route and an inducement time for the incentive, and instructs the information presentation terminal installed at least at a starting point of the identified route to present information corresponding to the selected incentive and inducement time.

2. The information presentation device according to claim 1, wherein
the communication unit receives the degree of congestion at predetermined intervals,
after the information management unit instructs the information presentation terminal to present information,
the calculation unit re-calculates the required time,
the prediction unit re-predicts the timing using the required time re-calculated by the calculation unit as an input to the predetermined device,
the information management unit determines whether the change in the information presentation is necessary at the re-predicted timing, selects the incentive and the inducement time for the incentive for the re-predicted timing when it is determined that the change is necessary, and instructs to change the information presentation.

3. The information presentation device according to claim 1, wherein
the inducement time is obtained in advance from records from the time when the information presentation is started by the incentive corresponding to the inducement time to the time when the congestion is mitigated, and is updated by the records at the time when the information presentation is ended.

4. An information presentation system comprising:
human flow sensors installed at predetermined intervals on each of a plurality of routes to a specific point;
information presentation terminals installed at least at a starting point of each of the routes;
a communication unit that receives the degree of congestion at each position in each of the routes from each of the human flow sensors;
a calculation unit that calculates the required time for each time series of the route on the basis of the degree of congestion at each position in each of the routes;
a prediction unit that inputs the time-series required time calculated for each of the routes to a predetermined device for predicting the required time of each of the routes learned in advance, and predicts the timing when the required time approaches the threshold for each of the routes as an output of the predetermined device; and
an information management unit that identifies a route that requires inducement from the timing predicted for each of the routes, selects an incentive for prompting a change in the identified route and an inducement time for the incentive, and instructs the information presentation terminal installed at a point of the identified route to present information corresponding to the selected incentive and inducement time.

5. The information presenting system according to claim 4, wherein
the information presentation terminal presents information by the incentive and displays information for assisting a moving speed of an inducement target.

6. An information presentation method for causing a computer to execute processing comprising:
receiving the degree of congestion at each position on each of a plurality of routes from each of human flow sensors installed at predetermined intervals on each of the plurality of routes to a specific point;
calculating the required time for each time series of the route on the basis of the degree of congestion at each position in each of the routes;
inputting the time-series required time calculated for each of the routes to a predetermined device for predicting the required time of each of the routes learned in advance, and predicting the timing when the required time approaches the threshold for each of the routes as an output of the predetermined device; and
identifying a route that requires inducement from the timing predicted for each of the routes, selecting an incentive for prompting a change in the identified route and an inducement time for the incentive, and instructing the information presentation terminal installed at least at a starting point of the identified route to present information corresponding to the selected incentive and inducement time.

7. (canceled)

8. The information presentation method according to claim 6, further comprising:
receiving updated information relating to the degree of congestion,
re-calculating the required time,
re-predicting the timing using the required time,
determining whether the change in the information presentation is necessary at the re-predicted timing,
upon determining that the change in the information presentation is necessary, selecting the incentive and the inducement time for the incentive for the re-predicted timing, and
instructing to change the information presentation.

9. A non-transitory computer storage medium storing instructions that, when executed on a computer, perform the method of claim 6.

10. The information presentation device according to claim 2, wherein
the inducement time is obtained in advance from records from the time when the information presentation is started by the incentive corresponding to the inducement time to the time when the congestion is mitigated, and is updated by the records at the time when the information presentation is ended.
